(19) United States
(12) Patent Application Publication
(10) Pub. No.: US 2001/0051453 A1
(43) Pub. Date: Dec. 13, 2001

(54) Connection method of a twisted pair electric wire and a press-fit joint connector in combination with a twisted pair electric wire

(75) Inventor: Kuniaki Tachi, Yokkaichi-city (JP)

Correspondence Address: GREENBLUM & BERNSTEIN, P.L.C., 1941 ROLAND CLARKE PLACE, RESTON, VA, 20191, US

(73) Assignee: SUMITOMO WIRING SYSTEMS, Ltd., Yokkaichi-City (JP)

(21) Appl. No.: 09/867,556

(22) Filed: May 31, 2001

(30) Foreign Application Priority Data
Jun. 1, 2000 (JP) 2000-165025

(51) Int. Cl. H01R 4/24; H01R 4/26; H01R 11/20

(52) U.S. Cl. 439/404

(57) ABSTRACT

Plural twisted pair electric wires are spliced by using a press-fit joint connector. The joint connector includes first and a second terminals spaced from each other in a wire inserting direction, each having plural blades. The blades of the first and second terminals are offset from each other in a direction substantially perpendicular to the wire inserting direction. First and second wires of a first twisted pair electric wire are press-fit to one blade of the first terminal and one blade of the second terminal adjacent to each other, respectively, at an intermediate position of the first twisted pair electric wire. Further, first and second wires of a second twisted pair electric wire are press-fit to another blade of the first terminal and another blade of the second terminal adjacent to each other, respectively, at an intermediate position or at an end of the second twisted pair electric wire.

### BACKGROUND OF THE INVENTION

1. Field of Invention

This invention relates to a press-fit (or press-slit) connection of electric wires, such as twisted pair electric wires. In particular, this invention improves a splice connection workability of the electric wires, such as the twisted pair electric wires, connecting between radio/audio equipment and speakers mounted in an automobile.

2. Description of Related Art

Recently, a twisted pair electric wire, which is formed by two electric wires twisted together at a predetermined pitch, is used to eliminate occurrence of noise due to an electromagnetic wave. For example, as shown in FIG. 9, since the electric wires that are connected to speakers carried in an automobile require elimination of noise, the radio/stereo equipment 1 is connected to the speakers 2 (front left woofer 2A, front left tweeter 2B, front right woofer 2C, front right tweeter 2D, rear left 2E, and rear right 2F) carried in an automobile by using twisted pair electric wires, as shown in FIGS. 10(A) and 10(B).

As shown in FIGS. 10(A) and 10(B), in the twisted pair electric wires W1 and W2, each of which is formed by twisting two electric wires, the twisted pair electric wire W1 (W1a and W1b), which are connected to the speaker for tweeter 2B, are connected with the twisted pair electric wire W2 (W2a and W2b), which are connected to the speaker for woofer 2A, at the splice point P. At this time, the electric wire W1a of the twisted pair electric wire W1 and the electric wire W2a of the twisted pair electric wire W2 are spliced to a splicing electric wire W3 to connect to the + (plus) side terminal of the equipment 1. Further, the electric wires W1b and W2b are spliced to an electric wire W4 to connect to the − (minus) side terminal of the equipment 1.

However, the above-described connection has the following problems.

(1) Since the electric wires are not twisted in the section using the splicing electric wire, it is easy for noise to occur.

(2) To avoid an overlap of splice points, one splice point is offset (or shifted) from another splice point. Accordingly, one of the electric wires should be folded, and workability (of the assembly) is inefficient.

(3) It is preferable that the length of the splicing electric wire is as short as possible. However, in that case, since the section in which the twisted pair electric wires are wired on a single path, the amount of the electric wires increase, and thus, high cost is required.

(4) To splice, one end of each electric wire should be stripped off and be connected to a crimping terminal by crimping. Accordingly, automation (of the assembly) is difficult, and the assembly takes long time.

(5) At the point of splice connection, the twisted pair electric wire should be untwisted. Accordingly, it is easy for noise to occur at the (untwisted) point, and the assembly is troublesome and takes a long time.

Accordingly, the present invention is provided in view of the above-described problems, and an objective of the present invention is to provide a connection method using a twisted pair electric wire as an electric wire that is connected to a plurality of twisted pair electric wires, that takes the place of the conventional splice connection and that provides efficient workability.

### SUMMARY OF THE INVENTION

To achieve the above and/or other goals, the present invention provides a method for connecting a twisted pair electric wire. First, a press-fit joint connector having a first press-fit terminal and a second press-fit terminal spaced from each other in a wire inserting direction is provided. A plurality of blade portions of the first press-fit terminal and a plurality of blade portions of the second press-fit terminal are offset from each other in a direction substantially perpendicular to the wire inserting direction. A first electric wire and a second electric wire forming a first twisted pair electric wire are press-fit to a first blade portion in the plurality of the blade portions of the first press-fit terminal and a first blade portion in the plurality of blade portions of the second press-fit terminal at an intermediate portion of the first twisted pair electric wire, respectively. The first blade portion of the first press-fit terminal and the first blade portion of the second press-fit terminal are adjacent to each other. Next, a first electric wire and a second electric wire forming a second twisted pair electric wire are press-fit to a second blade portion in the plurality of blade portions of the first press-fit terminal and a second blade portion in the plurality of blade portions of the second press-fit terminal at a first end of the second twisted pair electric wire, respectively. The second blade portion of the first press-fit terminal and the second blade portion of the second press-fit terminal are adjacent to each other. One end of the first twisted pair electric wire is connected to a power source. Another end of the first twisted pair electric wire is connected to a first load. A second end of the second twisted pair electric wire is connected to a second load. Thus, the intermediate portion of the first electric wire of the first twisted pair electric wire is spliced to the first end of the first electric wire of the second twisted pair electric wire and the intermediate portion of the second electric wire of the first twisted pair electric wire is spliced to the first end of the second electric wire of the second twisted pair electric wire.

For example, the power source can be a radio or an audio device. The load can be, for example, a speaker.

According to the above-described construction, since one twisted pair electric wire that is press-fit at its intermediate position is wired through the total length extending between the power source to the load (speaker), it is difficult for noise to be generated. Further, since a plurality of twisted pair electric wires are connected by press-fitting using the press-fit joint connector, workability improves as compared with the conventional splice connecting operation using a crimp-style terminal.

Further, the press-fit joint connector has press-fit blade portions connected to the first electric wires of twisted pair electric wires by press-fitting and press-fit blade portions connected to the second electric wires of twisted pair electric wires by press-fitting, which are offset (staggered) from each other. Thus, each twisted pair electric wire can maintain its twisted condition and can be connected to adjacent press-fit blade portions by press-fitting. In other words, the first electric wires and the second electric wires are not required to be rearranged so that the first electric wires and the second electric wires are respectively adjacent to each other. Accordingly, since each twisted pair electric wire is not required to be untwisted and rearranged at the press-fit connection point, the press-fit connecting operation can be automated.

In another aspect of the present invention, a method for connecting a twisted pair electric wire including the following processes are provided. First, a press-fit joint connector having a first press-fit terminal and a second press-fit terminal spaced from each other in a wire inserting direction is provided. A plurality of blade portions of the first press-fit terminal and a plurality of blade portions of the second press-fit terminal are offset from each other in a direction substantially perpendicular to the wire inserting direction. A first electric wire and a second electric wire forming a first twisted pair electric wire are press-fit to a first blade portion in the plurlity of the blade portions of the first press-fit terminal and a first blade portion in the plurality of blade portions of the second press-fit terminal at an intermediate portion of the first twisted pair electric wire, respectively. The first blade portion of the first press-fit terminal and the first blade portion of the second press-fit terminal are adjacent to each other. A first electric wire and a second electric wire forming a second twisted pair electric wire are press-fit to a second blade portion in the plurality of blade portions of the first press-fit terminal and a second blade portion in the plurality of blade portions of the second press-fit terminal at an intermediate position of the second twisted pair electric wire, respectively. The second blade portion of the first press-fit terminal and the second blade portion of the second press-fit terminal are adjacent to each other. Then, one of the plurality of twisted pair electric wires is connected to a power source, and the plurality of twisted pair electric wires other than the one connected to the power source is connected to loads.

According to the construction as described above, for example, a circuit that extends between power source, such as radio/audios, and three loads, such as speakers, can be formed by using two twisted pair electric wires. Further, when three twisted pair electric wires are used, four (or five) loads can be connected to the power sources.

In a still further aspect of the present invention, in combination with a plurality of twisted pair electric wires, a press-fit joint connector that splices the plurality of twisted pair electric wires is provided. The press-fit joint connector includes a base portion and a first press-fit terminal provided in the base portion. The first press-fit terminal has first and second blade portions. The press-fit joint connector further includes a second press-fit terminal provided in the base portion. The second press-fit terminal having third and fourth blade portions being offset from and adjacent to the first and second blade portions of the first press-fit terminal, respectively, in a first direction substantially perpendicular to a wire inserting direction. A first electric wire and a second electric wire forming a first twisted pair electric wire in the plurality of twisted pair electric wires are press-fit to the first blade portion and the third blade portion, respectively, at an intermediate position of the first twisted pair electric wire. Further, a first electric wire and a second electric wire forming a second twisted pair electric wire in the plurality of twisted pair electric wires are press-fit to a second blade portion and a fourth blade portion, respectively.

Preferably, the first press-fit terminal and the second press-fit terminal extend in the first direction and are spaced from each other in the wire inserting direction. The press-fit joint connector may further include a lid portion. The second twisted pair electric wire can be press-fit to the press-fit terminals either at an end or at an intermediate position of the second twisted pair electric wire.

In another aspect of the present invention, a press-fit joint connector is provided. The press-fit joint connector includes a base portion, a first press-fit terminal provided in the base portion, the first press-fit terminal having first and second blade portions, and a second press-fit terminal provided in the base portion, the second press-fit terminal having third and fourth blade portions offset from and adjacent to the first and second blade portions of the first press-fit terminal, respectively, in a first direction.

### BRIEF DESCRIPTION OF THE DRAWINGS

The present invention is further described in the detailed description which follows, with reference to the noted plurality of drawings by way of non-limiting examples of exemplary embodiments of the present invention, in which like reference numerals represent similar parts throughout the several views of the drawings, and wherein:

FIG. 1 is a view illustrating a circuit to which the present invention is applied.

FIG. 2 is a perspective view of a connection of electric wires according to a first embodiment of the present invention.

FIGS. 3(A) and 3(B), respectively, are a perspective view of a press-fit joint connector and a perspective view of a press-fit terminal according to the first embodiment of the present invention.

FIGS. 4(A) and 4(B) are perspective views illustrating a case in which the press-fit joint connector is connected to twisted pair electric wires according to the first embodiment of the present invention.

FIG. 5 is a view illustrating a circuit to which a second embodiment of the present invention is applied.

FIG. 6 is a perspective view illustrating a press-fit joint connector according to the second embodiment of the present invention.

FIG. 7 is a perspective view illustrating a case in which twisted pair electric wires are press-fit to the press-fit joint connector according to the second embodiment of the present invention.

FIGS. 8(A) and 8(B) are perspective views illustrating a case in which a press-fit joint connector is press-fit to the twisted pair electric wires according to a third embodiment of the present invention.

FIG. 9 is a view illustrating a circuit in which twisted pair electric wires are used.

FIGS. 10(A) and 10(B) are perspective views illustrating a conventional splice connection.

### DETAILED DESCRIPTION OF PREFERRED EMBODIMENTS

The embodiments of the present invention are explained in the following with reference to figures.

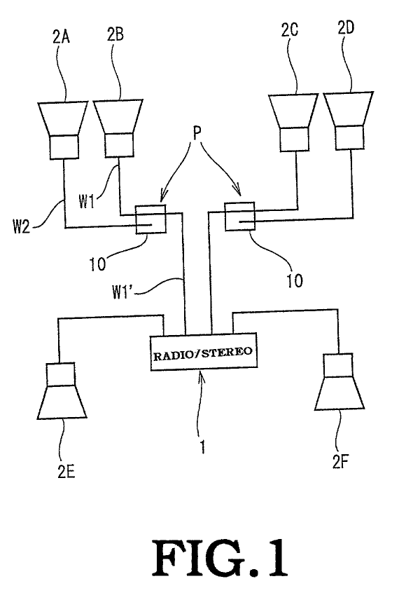

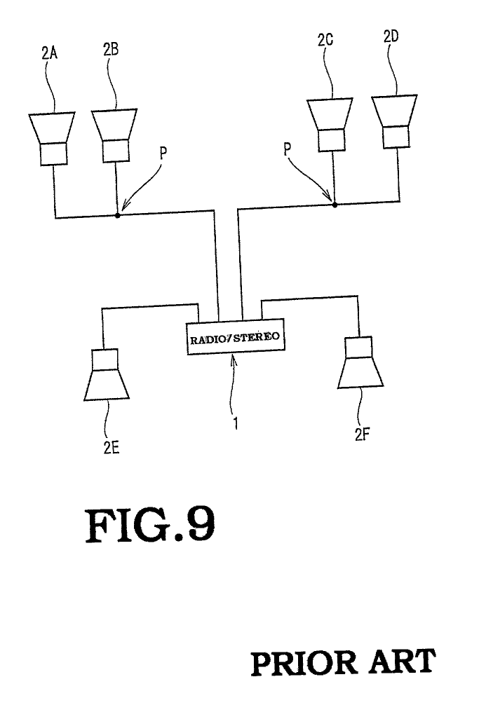

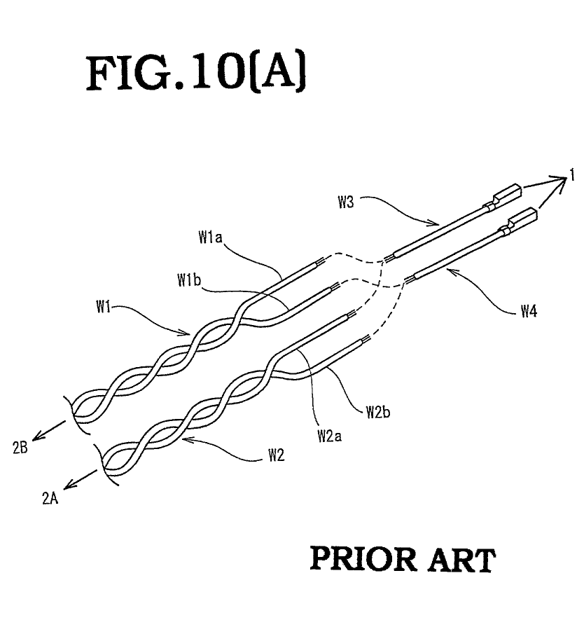

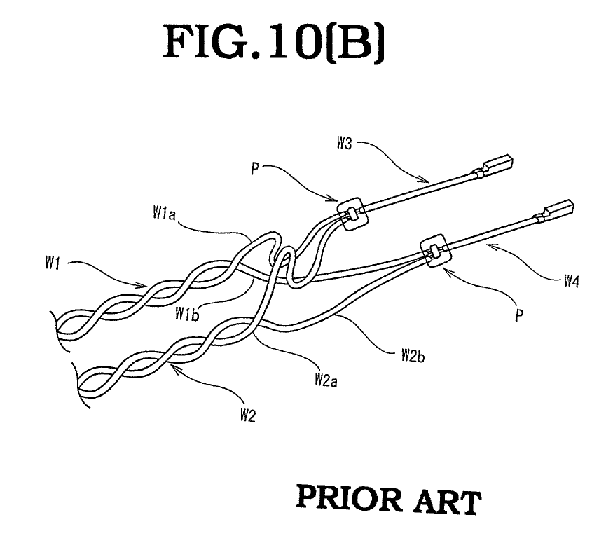

FIG. 1 through FIG. 4(B) illustrate a first embodiment of the present invention. In the first embodiment, the present invention is applied to a circuit shown in FIG. 1 that connects the radio/audio equipment 1 to speakers 2A-2F, similar to that shown in FIG. 9.

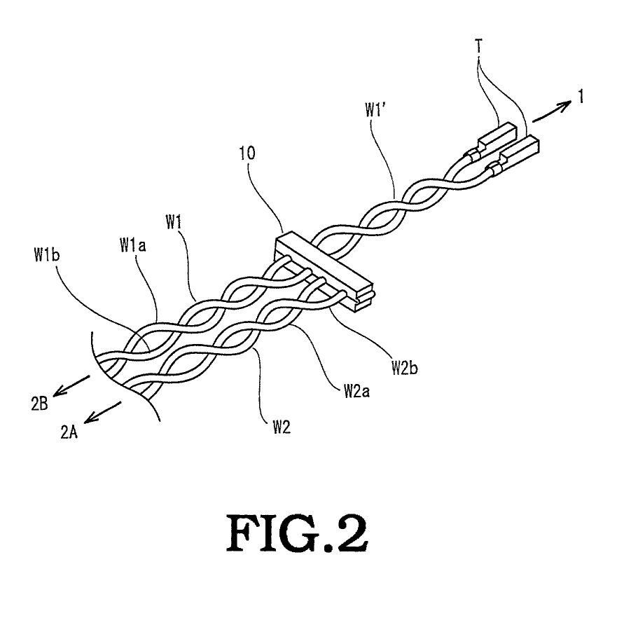

In other words, the twisted pair electric wire W1 (W1a and W1b) connected to the speaker 2B for the left woofer and the twisted pair electric wire W2 (W2a and W2b) connected to the speaker 2A for the left tweeter are connected to an electric wire connected to the radio/audio equipment 1 at the splice point P (FIGS. 1 and 2). In the present invention, the electric wire extending between the splice point P and the equipment 1 is formed by a twisted pair electric wire. The electric wire connecting the speaker 2C for the right woofer and the speaker 2D for the right tweeter with the radio/audio equipment 1 is similarly formed.

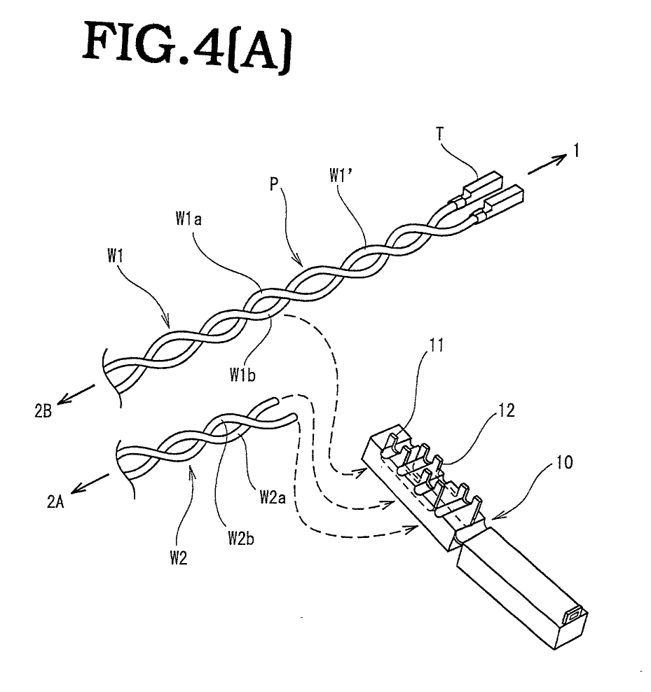

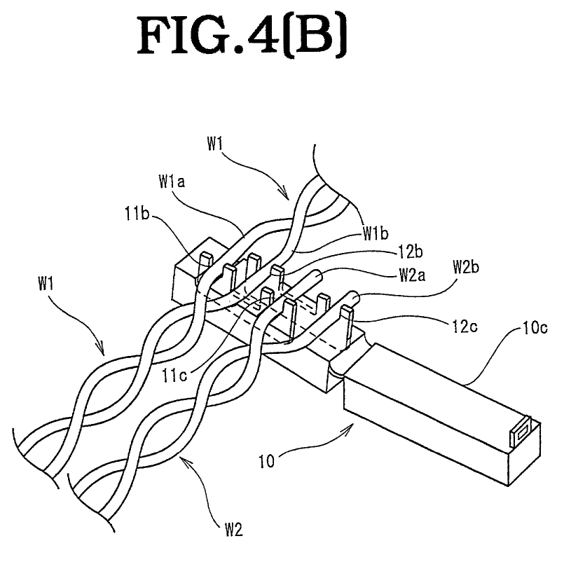

As shown in FIGS. 2, 4(A) and 4(B), the twisted pair electric wire W1 is formed by twisting a first electric wire W1a and a second electric wire W1b at a predetermined pitch by using a twisting jig (not shown). The twisted pair electric wire W2 is similarly formed by twisting a first electric wire W2a and a second electric wire W2b at a predetermined pitch.

The twisted pair electric wire W1 has a length to extend between the speaker 2B and the equipment 1 and has one end connected to terminals T. On the other hand, the twisted pair electric wire W2 has a length to extend between the speaker 2A and the splice point P.

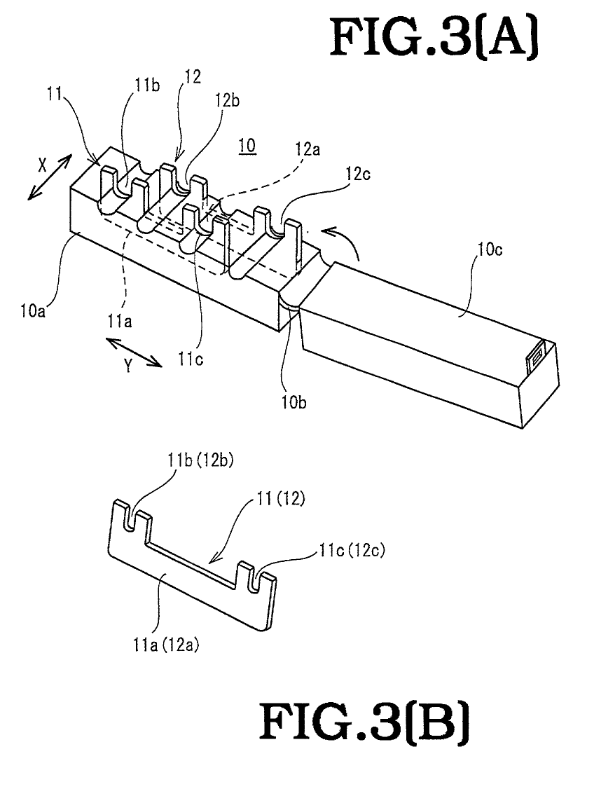

At the splice point P, an intermediate position of the twisted pair electric wire W1 is press-fit to and an end of the twisted pair electric wire W2 is press-fit to a press-fit joint connector 10 as shown in FIGS. 3(A) and 3(B).

The press-fit joint connector 10 includes a first press-fit terminal 11 and a second press-fit terminal 12. The first press-fit terminal 11 includes a base plate 11a and a pair of press-fit blade portions 11b and 11c projecting from an upper surface (edge) of the base plate 11a. The second press-fit terminal 12 includes a base plate 12a and a pair of press-fit blade portions 12b and 12c projecting from an upper surface (edge) of the base plate 12a. The base plate 11a of the first press-fit terminal 11 and the base plate 12a of the second press-fit terminal 12 are mounted in a case body 10a so as to be spaced in the direction X, in which the electric wire is inserted, and to be offset from each other in the direction Y, which is perpendicular to the direction X. Thus, the press-fit blade portions 11b and 11c projecting from the base plate 11a and the press-fit blade portions 12b and 12c projecting from the base plate 12a are respectively staggered (offset) from each other in the direction Y. In other words, although the press-fit blade portions 11b and 11c are spaced from the press-fit blade portions 12b and 12c in the X direction, in which the electric wire is inserted, the press-fit blade portions 11b, 12b, 11e and 12c are adjacent to each other in this order (in the Y direction).

Further, a lid 10c is provided to one end of the case body 10a by using a hinge 10b. When the lid 10c is closed to the case body 10a, electric wires, which are respectively inserted into the press-fit blade portions 11b-12c, each of which has a pair of opposing blade edges, are pressed into the pairs of blade edges. Thus, the electric wires are press-fit. The lid 10c is locked to the case body 10a in a closing condition by complementary latch portions, only one of which is shown on lid 10c. At this time, insulation covering the electric wires is stripped off by the pressing force and contact between the wires and the respective press-fit terminal is established.

As shown in FIGS. 4(A) and 4(B), the twisted pair electric wires W1 and W2, each of which maintains its twisted condition, are inserted into the press-fit joint connector 10. More specifically, the intermediate portions (at the splice point P) of the first electric wire W1a and the second electric wire W1b of the twisted pair electric wire W1 are inserted into the adjacent press-fit blade portions 11b and 12b, respectively. On the other hand, terminals at one end (splice position P) of the first electric wire W2a and the second electric wire W2b of the twisted pair electric wire W2 are inserted into adjacent press-fit blade portions 11c and 12c, respectively.

When the lid 10c is closed in this condition, the electric wires W1a-W2b are press-fit to the press-fit blade portions 11b-12c, respectively. The first electric wire W2a of the twisted pair electric wire W2 is spliced to the first electric wire W1a of the first twisted pair electric wire W1 via the first press-fit terminal 11. Similarly, the second electric wire W2b of the twisted pair electric wire W2 is spliced to the second electric wire W1b of the twisted pair electric wire W1 via the second press-fit terminal 12.

Accordingly, the twisted pair electric wire W1 crosses over the press-fit joint connector 10 and extends between the position where the twisted pair electric wire W1 is connected to the press-fit joint connector 10 to the position where one end of the twisted pair W1 is connected to the terminals T. Thus, a twisted pair electric wire W1′ is formed between the splice point P and the equipment 1.

As described above, when the intermediate portion of the twisted pair electric wire W1 and the end of the twisted pair electric wire W2 are connected by press-fitting using the press-fit joint connector 10, all the wiring section between the equipment 1 and the speakers 2A and 2B can be formed by twisted pair electric wires, and thus, noise shielding function (efficiency) improves.

Further, since, on the press-fit joint connector 10, each pair of adjacent press-fit blade portions are offset (staggered) from each other, the twisted pair electric wires W1 and W2 are not required to be untwisted and the first electric wires and the second electric wires are not required to be arranged adjacently. Thus, the twisted pair electric wires maintain the twisted condition and are merely inserted into the press-fit blade portions in a straight condition. Accordingly, automation can be achieved by using the press-fit joint connector 10, and thus, workability improves.

In the above-described embodiment, the direction in which the press-fit blade portions are offset and the wire inserting direction are perpendicular to each other. However, it is not necessary to be perpendicular to each other. They can be arranged at any angle as long as the electronic wires can be inserted into the press-fit blade portions without overly bending the electric wires.

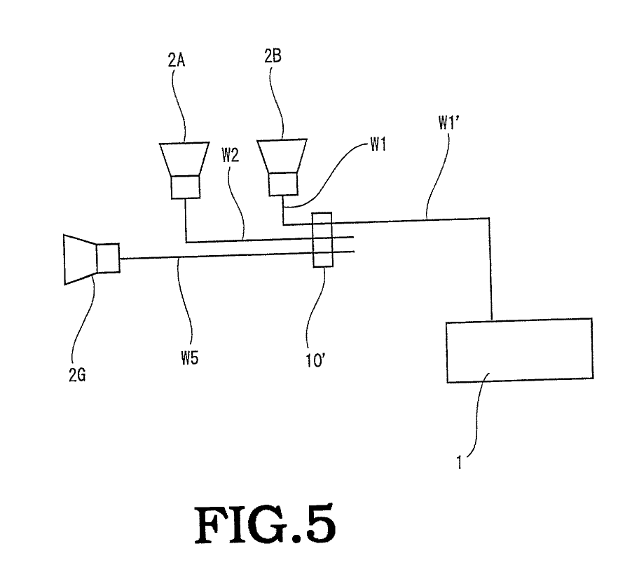

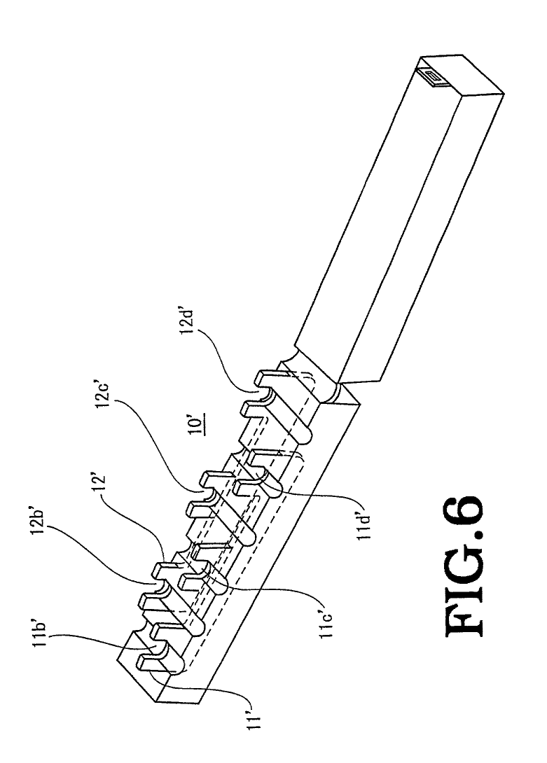

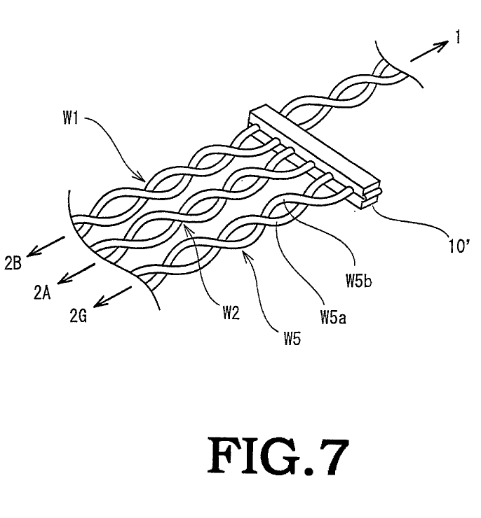

FIGS. 5 through 7 illustrate a second embodiment of the present invention. In the second embodiment, a circuit connected to the radio/audio equipment 1 is also connected to three speakers 2A, 2B and 2G. Similar to the first embodiment, one end of the twisted pair electric wire W1 is connected to the speaker 2B, and one end of the twisted pair electric wire W2 is connected to the speaker 2A. Another twisted pair electric wire W5 is connected to the speaker 2G.

In this case, a first press-fit terminal 11′ and a second press-fit terminal 12′ provided in the press-fit joint connector 10′ have three press-fit blade portions 11b′-11d′ and 12b′-12d′, respectively. Further, the press-fit blade portions of the first press-fit terminal 11′ and the press-fit blade portions of the second press-fit terminal 12′ are offset (staggered) from each other.

One end of a first electric wire W5a in the twisted pair electric wire W5 connected to the speaker 2G is press-fit to the press-fit blade portion 11d′ of the first press-fit terminal 11′ on the press-fit joint connector 10′. Further, one end of a second electric wire W5b is press-fit to the press-fit blade portion 12d′ of the second press-fit terminal 12′. The twisted pair electric wires W1 and W2 are connected in the same manner as the first embodiment.

According to the above-described construction, the twisted pair electric wire can be used throughout the total length of wiring among the radio/audio equipment 1 and the three speakers 2A, 2B and 2G.

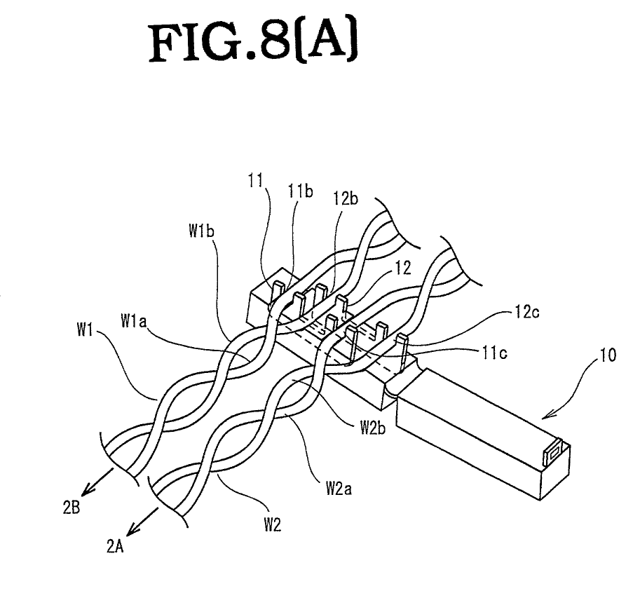

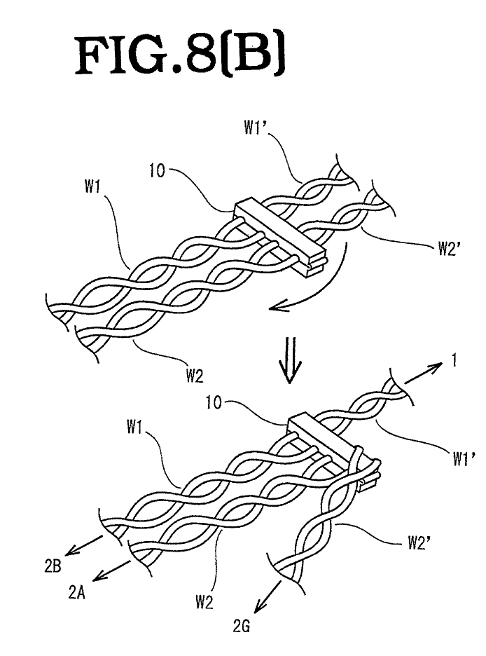

FIGS. 8(A) and 8(B) illustrate a third embodiment of the present invention. Similar to the second embodiment shown in FIG. 5, three speakers 2A, 2B and 2G (refer to FIG. 5) are connected to a circuit connected to the radio/audio equipment 1. Similar to the first embodiment, one end of the twisted pair electric wire W1 is connected to the speaker 2B, and one end of the twisted pair electric wire W2 is connected to the speaker 2A.

In the third embodiment, a press-fit joint connector which is the same as that of the first embodiment is used. Similar to the twisted pair electric wire W1, the intermediate portions (splice point P) of the first electric wire W2a and the second electric wire W2b of the twisted pair electric wire W2, are press-fit to the press-fit blade portion 11c of the first press-fit terminal 11 and the press-fit blade portion 12c of the second press-fit terminal 12, respectively.

The twisted pair electric wire W2′, which corresponds to the twisted pair electric wire W2 press-fit to and crossing over the press-fit joint connector 10 and extending to the other side, is folded and connected to the speaker 2G. The twisted pair electric wire W1′, which corresponds to the twisted pair electric wire W1 extending toward the other side of the press-fit joint connector 10, is connected to the radio/audio equipment 1, similar to the first embodiment.

According to the construction described above, by using two twisted pair electric wires W1 and W2, and by press-fitting their intermediate portions to the press-fit joint connectors 10, the radio/audio equipment 1 can be connected to the three speakers 2A, 2B and 2G via the twisted pair electric wires.

As clearly described above, according to the present invention, a press-fit joint connector is used. The first press-fit terminal and the second press-fit terminal, which are mounted in the press-fit joint connector, are arranged so as to be spaced from each other in the direction in which an electric wire is inserted. Further, the press-fit blade portion provided on the first press-fit terminal and the press-fit blade portion of the second press-fit terminal are offset (or staggered) from each other. Accordingly, when the twisted pair electric wires that maintain the twisted condition and thus are not untwisted are inserted into the press-fit blade portions adjacent to each other on the press-fit joint connector, and are press-fit to the press-fit joint connector, the first and second electric wires of one twisted pair electric wire can be connected by press-fitting with the first and second electric wires of another twisted pair electric wire, respectively. Accordingly, the workability of the splice connection of the twisted pair electric wires can improve and automation can be achieved.

Conventionally, since a twisted pair electric wire is connected to a splicing electric wire, which is not a twisted pair electric wire, the total length extending between a power source side equipment, such as a radio/audio equipment, and a load side equipment, such as a speaker, is not formed by a twisted pair electric wire. Accordingly, noise shielding efficiency was not sufficient. However, in this invention, since the total length can be formed by twisted pair electric wires, noise shielding efficiency can be improved.

In addition, according to the present invention, the splicing electric wire, which is conventionally required, is no longer necessary. Further, there is an advantage that the total length can be formed by twisted pair electric wires by merely press-fitting the intermediate point of one of the plurality of twisted pair electric wires.

In the above-described embodiment, the first press-fit terminal and the second press-fit terminal have an identical shape. Accordingly, by shifting one from the other in the direction perpendicular to the wire inserting direction, the blade portions are arranged so as to be offset from each other. According to this construction, since the first and second press-fit terminals can share an identical component, the number of kinds of components to form the press-fit joint connector can be reduced. However, the first and second press-fit terminals can have different shapes. For example, the length between two blade portions 11b and 11c can be longer than the length between two blade portions 12b and 12c. In that case, FIG. 3(A) can be modified so that the blade portions 12b and 12c are arranged outside of the blade portions 11b and 11c in the direction perpendicular to the wire inserting direction. Even in this arrangement, the blade portions 11b and 11c are adjacent to the blade portions 12b and 12c, respectively. Thus, the same effect as the above-described embodiment can be achieved.

Further, as described above, it is preferable that the first press-fit terminal and the second press-fit terminal are arranged so as to be spaced from each other in the wire inserting direction to enable the splicing points to be offset from (or not to overlap) each other. However, the arrangement of the first and second press-fit terminal that are not spaced from each other in the wire inserting direction is also acceptable. For example, the base portion of one press-fit terminal can be mounted under the base portion of another press-fit terminal.

In the above-described embodiment, both press-fit terminals are mounted in the case body 10a of the press-fit joint connector. However, it is possible to mount one of the press-fit terminals in the lid portion 10c. In this case, by properly arranging the press-fit terminals, the blade portions can have the arrangement similar to that of the above-described embodiment, after the lid is closed, and thus the effect similar to the above-described embodiment can be achieved.

Further, although the press-fit terminals are arranged in parallel in the above-described embodiment, it is not necessary to be arranged in parallel. Thus, a variety of modification in arrangement of blade portions on the press-fit terminal is available.

It is noted that the foregoing examples have been provided merely for the purpose of explanation and are in no way to be construed as limiting of the present invention. While the present invention has been described with reference to certain embodiments, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

The present disclosure relates to subject matter contained in priority Japanese Application No. HEI 2000-165025, filed on Jun. 1, 2000, which is herein expressly incorporated by reference in its entirety.

What is claimed is:

1. A method for connecting a twisted pair electric wire, comprising:
providing a press-fit joint connector having a first press-fit terminal and a second press-fit terminal spaced from each other in a wire inserting direction, a plurality of blade portions of the first press-fit terminal and a plurality of blade portions of the second press-fit terminal being offset from each other in a direction substantially perpendicular to the wire inserting direction;
press-fitting a first electric wire and a second electric wire forming a first twisted pair electric wire to a first blade portion in the plurality of the blade portions of the first press-fit terminal and a first blade portion in the plurality of blade portions of the second press-fit terminal at an intermediate portion of the first twisted pair electric wire, respectively, the first blade portion of the first press-fit terminal and the first blade portion of the second press-fit terminal being adjacent to each other;
press-fitting a first electric wire and a second electric wire forming a second twisted pair electric wire to a second blade portion in the plurality of blade portions of the first press-fit terminal and a second blade portion in the plurality of blade portions of the second press-fit terminal at a first end of the second twisted pair electric wire, respectively, the second blade portion of the first press-fit terminal and the second blade portion of the second press-fit terminal being adjacent to each other;
connecting one end of the first twisted pair electric wire to a power source;
connecting another end of the first twisted pair electric wire to a first load; and
connecting a second end of the second twisted pair electric wire to a second load,
whereby the intermediate portion of the first electric wire of the first twisted pair electric wire is spliced to the first end of the first electric wire of the second twisted pair electric wire and the intermediate portion of the second electric wire of the first twisted pair electric wire is spliced to the first end of the second electric wire of the second twisted pair electric wire.

2. The method according to claim 1, wherein the power source is at least one of a radio and an audio device, and the load is a speaker.

3. The method according to claim 1, further comprising:
press-fitting a first electric wire and a second electric wire forming a third twisted pair electric wire to a third press-fit blade portion in the plurality of press-fit blade portions of the first press-fit terminal and a third press-fit blade portion in the plurality of press-fit blade portions of the second press-fit terminal adjacent to each other at a first end of the third twisted pair electric wire, respectively; and
connecting a second end of the third twisted pair electric wire to a load.

4. A method for connecting a twisted pair electric wire, comprising:
providing a press-fit joint connector having a first press-fit terminal and a second press-fit terminal spaced from each other in a wire inserting direction, a plurality of blade portions of the first press-fit terminal and a plurality of blade portions of the second press-fit terminal being offset from each other in a direction substantially perpendicular to the wire inserting direction;
press-fitting a first electric wire and a second electric wire forming a first twisted pair electric wire to a first blade portion in the plurality of the blade portions of the first press-fit terminal and a first blade portion in the plurality of blade portions of the second press-fit terminal at an intermediate position of the first twisted pair electric wire, respectively, the first blade portion of the first press-fit terminal and the first blade portion of the second press-fit terminal being adjacent to each other;
press-fitting a first electric wire and a second electric wire forming a second twisted pair electric wire to a second blade portion in the plurality of blade portions of the first press-fit terminal and a second blade portion in the plurality of blade portions of the second press-fit terminal at an intermediate position of the second twisted pair electric wire, respectively, the second blade portion of the first press-fit terminal and the second blade portion of the second press-fit terminal being adjacent to each other;
connecting one of the plurality of twisted pair electric wires to a power source;
connecting the plurality of twisted pair electric wires other than the one connected to the power source to loads.

5. The method according to claim 2, wherein the power source is at least one of a radio and an audio device, and the load is a speaker.

6. In combination with a plurality of twisted pair electric wires, a press-fit joint connector that splices the plurality of twisted pair electric wires, the press-fit joint connector comprising:
a base portion;
a first press-fit terminal provided in the base portion, the first press-fit terminal having first and second blade portions;
a second press-fit terminal provided in the base portion, the second press-fit terminal having third and fourth blade portions offset from and adjacent to the first and second blade portions of the first press-fit terminal, respectively, in a first direction substantially perpendicular to a wire inserting direction;
wherein a first electric wire and a second electric wire forming a first twisted pair electric wire in the plurality of twisted pair electric wires are press-fit to the first blade portion and the third blade portion, respectively, at an intermediate position of the first twisted pair electric wire, and
wherein a first electric wire and a second electric wire forming a second twisted pair electric wire in the plurality of twisted pair electric wires are press-fit to a second blade portion and the fourth blade portion, respectively.

7. The press-fit joint connector according to claim 6, further comprising:
a lid portion openable to and closeable from the base portion.

8. The press-fit joint connector according to claim 7, wherein the lip portion is connected to the base portion by a hinge.

9. The press-fit joint connector according to claim 6, wherein each of the first and second press-fit terminals extends in the first direction, and the first press-fit terminal and the second press-fit terminal are spaced from each other in the wire inserting direction.

10. The press-fit joint connector according to claim 6, wherein the first and second electric wires of the second twisted pair electric wire are press-fit to the second and fourth blade portions at an end of the second twisted pair electric wire.

11. The press-fit joint connector according to claim 6, wherein the first and second electric wires of the second twisted pair electric wire are press-fit to the second and fourth blade portions at an intermediate position of the second twisted pair electric wire.

12. The press-fit joint connector according to claim 10, wherein one end of the first twisted pair electric wire is connected to a power source, and another end of the first twisted pair and another end of the second twisted pair electric wire are respectively connected to loads.

13. The press-fit joint connector according to claim 11, wherein one end of the first twisted pair electric wire is connected to a power source, and another end of the first twisted pair and each end of the second twisted pair electric wire are respectively connected to loads.

14. A press-fit joint connector comprising:
a base portion;
a first press-fit terminal provided in the base portion, the first press-fit terminal having first and second blade portions; and
a second press-fit terminal provided in the base portion, the second press-fit terminal having third and fourth blade portions offset from and adjacent to the first and second blade portions of the first press-fit terminal, respectively, in a first direction.

15. The press-fit joint connector according to claim 14, wherein each of the first and second press-fit terminals extends in the first direction, and the first press-fit terminal and the second press-fit terminal are spaced from each other in a wire inserting direction, which is different from the first direction.
